(19) United States
(12) Patent Application Publication
(10) Pub. No.: US 2010/0066791 A1
(43) Pub. Date: Mar. 18, 2010

(54) Inkjet Printing Apparatus and Method

(76) Inventors: Natasha Jeremic, Bedfordshire (GB); Shaun Christopher Hazlewood, Suffolk (GB)

Correspondence Address: MORGAN LEWIS & BOCKIUS LLP, 1111 PENNSYLVANIA AVENUE NW, WASHINGTON, DC, 20004, US

(21) Appl. No.: 12/516,837

(22) PCT Filed: Nov. 30, 2007
(86) PCT No.: PCT/GB07/04591

§ 371 Date: May 29, 2009

(30) Foreign Application Priority Data
Dec. 2, 2006 (GB) 0624123.6

(51) Int. Cl. B41J 2/01

(52) U.S. Cl. 347/102

(57) ABSTRACT

There is provided an apparatus and method for inkjet printing, particularly thermal inkjet printing, in which at least one radiation-curing device for curing the radiation-curable ink is integral with, and downstream of, the inkjet printing station. The inkjet printing apparatus further includes a plurality of commercial replaceable inkjet printer cartridges with integral printheads, mounted into a print carriage in fixed array positioned at a set distance above a continuously—moving industrial print media carried on a conveyor or on a web or sheet to engage non-contact printing on said industrial print media with photo-quality, multi-colour print capability.

### FIELD OF THE INVENTION

This invention relates to a commercial apparatus and method for inkjet printing, particularly thermal inkjet printing, in which at least one radiation-curing device for curing the radiation-curable ink is integral with, and downstream of, the inkjet printing station. The inkjet printing apparatus further includes a plurality of commercial replaceable inkjet printer cartridges with integral printheads, mounted into a print carriage in fixed array positioned at a set distance above a continuously-moving industrial print media carried on a conveyor or on a web or sheet to engage non-contact printing on said industrial print media with photo-quality, multi-colour print capability.

### BACKGROUND TO THE INVENTION

Current methods of printing in the flexible packaging sector, particularly in the food and medical packaging industries rely on a combination of print technologies to achieve a packaged product that has photo-quality imagery suitable for consumer-facing packaging, and also the necessary product bar-coding and marking information to indicate the relevant production details. These two print applications are typically achieved using a combination of flexography, rotogravure or offset type printing for printing the required high resolution imagery for the consumer-facing packaging, and the significantly faster, but lower resolution technology of either thermal printing or continuous inkjet printing for printing the product bar-coding and marking on the finished product.

As print technologies, flexography, rotogravure and offset printing are time-consuming due to the need to produce purposely-designed printing plates and/or cylinders with relief patterns particular to each colour of the pattern. Secondly, these print technologies involve contact printing, where each ink must necessarily be dried prior to application of the next in order to prevent colour bleed and/or smearing of the printed image. These requirements therefore introduce undesirable time constraints on the printing process, subsequently impacting on the overall throughput.

The second print technology, continuous inkjet printing is a digitally-controlled printing technique that uses a pressurized ink source to produce a continuous stream of ink drops, which are directed to an appropriate location using one of several methods (electrostatic deflection, heat deflection, gas deflection, etc.). However, this deflection process typically results in low drop placement accuracy, with only a small percentage of the droplets generated actually being used to print; the rest are recycled through an integrated ink recirculation system. This need for a recirculation system adds additional cost and size to the printer system.

It is seen therefore that there is a need for a high resolution, high throughput print technology that combines the printing of packaging and barcode labelling in a single printer system, thereby realizing more cost-effective commercial printing of consumer-facing packaged products. The main drawback to realizing such a combined packaging and coding/labelling printing operation however, relates to the drying time needed between each print step to avoid colour bleed or smearing of the printed image.

Drop-on-demand inkjet printing is a non-contact printing method that provides ink drops for impact upon a print surface delivered using a pressurization actuator (thermal, piezoelectric, etc.). Selective activation of the actuator causes the formation and ejection of an ink drop through a nozzle bore that strikes the industrial print media. The formation of print images is achieved by controlling the individual formation of ink drops, as is required to create the desired image. With piezoelectric actuators, an electric field is applied to a piezoelectric material possessing properties that create a mechanical stress in the material causing an ink drop to be expelled. With thermal actuators, a heater, placed at a convenient location, heats the ink causing a quantity of ink to phase change into a gaseous steam bubble that raises the internal ink pressure sufficiently for an ink drop to be expelled. Thermal inkjet printing has advantages over piezoelectric printing, with printers and printheads being lower cost and with the printing process being able to achieve better resolution.

In contrast to the high resolution and excellent print quality achieved using desktop inkjet printers, where printing proceeds with a controlled stepwise motion of the print medium, accomplishing this same print quality in an industrial environment using the same stepwise motion is highly impractical since production lines typically employ continuous webs to convey the print medium, such that the thermal inkjet printed features are printed in a single pass. Such rapid thermal inkjet printing requires that a plurality of accurately-aligned thermal inkjet printheads with good lateral stability be positioned above the print area in fixed array, and that the subsequent thermal inkjet printed features be dried sufficiently to ensure that inter-colour bleed and smearing are necessarily avoided. Lateral stability of the industrial print medium is also essential to ensure that the high resolution print capability of the thermal inkjet printheads is not compromised. Conventional thermal inkjet inks, while needing a small percentage of water or volatile organic solvent in the liquid vehicle to achieve effective bubble nucleation, largely contain a high degree of water, which results in proportionally longer drying times than typical solvent-based inks. As such, effective drying of the printed feature is achieved only at the expense of production rate. This limitation has therefore precluded thermal inkjet printing from being considered an appropriate print technology for industrial application.

Attempts to circumvent this limitation have resulted in several disclosures. U.S. 2006/0075916 describes a method to circumvent the extended drying issue by coating the print medium with an ink receptive layer prior to inkjet printing. U.S. Pat. No. 6,957,886 on the other hand discloses an apparatus that includes a series of heaters; the first and second heaters being used to heat the industrial print medium prior to printing, while the third heater is used to cure the printed image. Several prior art documents including U.S. Pat. No. 6,454,405, U.S. 2006/0192829, and U.S. 2006/0023026 disclose inkjet printer systems with an integrated radiation-curing means to cure inkjet printed ink, yet none describe specific apparatus and methodology to print and cure a radiation-curable thermal inkjet ink.

A recent development in thermal inkjet ink technology has introduced the concept of radiation-curable inks for thermal inkjet printing. GB 0519941.9 discloses thermal inkjet inks comprising radiation-curable materials that enable the ink to be cured rapidly on exposure to an actinic radiation source without the need to drive off large quantities of water or solvent.

As such, it is seen therefore desirable to introduce this recent ink technology into a conventional thermal inkjet printing system to provide a commercial print technology that combines the print applications of mailing and addressing, product bar-coding and labelling, with the more demanding print application of consumer-facing packaging, to realize a superior alternative to the technology of current commercial printers, thereby enabling the production of photo-quality images in high throughput.

### SUMMARY OF THE INVENTION

The present invention relates to methods and systems for curing radiation-curable inkjet inks, particularly radiation-curable thermal inkjet inks, printed on industrial print media using a thermal inkjet printer. The methods and systems include radiation sources that are either integral with a thermal inkjet printer or that can be added to an existing thermal inkjet printer.

As used in connection with the present invention, the term “curing” may include partial “tack” curing of, or “complete” curing of the radiation-curable ink. In some instances, the initial dose of radiation may only partially cure the ink with a later dose provided to complete the curing process.

In a first aspect of the present invention, there is provided a method for printing and curing a radiation-curable thermal inkjet ink in which at least one radiation curing device is integral with, and downstream of, or in proximity to an inkjet printing station. The inkjet printing apparatus further includes a plurality of replaceable inkjet cartridges with integral printheads, mounted into a print carriage in fixed page-wide array of the industrial print media, positioned at a set distance above a continuously-moving industrial print media carried on a conveyor or on a web or sheet to engage non-contact printing on said industrial print media with photo-quality, multi-colour print capability.

In a second aspect of the present invention, there is provided a method for printing and curing a radiation-curable thermal inkjet ink in which at least one radiation curing device is integral with, and downstream of, or in proximity to an inkjet printing apparatus. The inkjet printing apparatus further includes a plurality of replaceable inkjet print cartridges with integral printheads, mounted into a bidirectionally-movable print carriage positioned across the web width at a fixed distance above the web to engage non-contact printing on said industrial print media with photo-quality, multi-colour print capability.

Suitable sources of actinic radiation include mercury lamps, xenon lamps, carbon arc lamps, tungsten filament lamps, lasers and the like. Optionally, the sources of radiation are lamps of a type commonly known as “instant-on, instant-off” lamps so that the time the radiation reaches the substrate can be precisely controlled. In a preferred embodiment of the invention, the curing device includes a single UV lamp. Preferably, the lamp is masked to direct radiation when activated only to a certain portion of the substrate. For example, the curing device may include a shield that extends substantially over the UV lamp. The shield has an opening for directing radiation only to a portion of the substrate that lies directly beneath the lamp. The radiation-curing light source may be triggered by industrial print media sensing sensors which detect the printing of the media and which activate the curing step.

Optionally, there is included a preliminary curing device, located downstream of the inkjet print cartridges with integral printheads, but upstream of the main radiation curing device, whereby the preliminary curing device employs an energy source similar to, or different from, the main curing device. Suitable preliminary curing sources include, but are not limited to the following radiation sources, actinic, infra red, microwave etc. In a preferred embodiment, the preliminary curing device is a low-powered UV lamp, used to at least partially (tack) cure a first printed ink prior to printing a second ink to prevent colour bleed and smearing. It is also desirable that the at least partial curing of a radiation-curable ink prevents the printed ink from spreading or beading on a print surface. In a further preferred embodiment, the optional preliminary curing device is an infra red lamp, used to drive off the residual solvent or water from the printed ink.

Optionally, the radiation-curing device may include a means to purge the printed image with a dinitrogen blanket to minimise the presence of oxygen during the radiation-curing stage, particularly in the case where the inkjet ink comprises oxygen-sensitive, free-radically curable components.

Optionally, the thermal inkjet printer uses an “off-axis” ink delivery system, having main stationary reservoirs for each ink (cyan, yellow, magenta and black) located in an ink supply region. In this respect, the term “off-axis” generally refers to a configuration where the ink supply is separated from the printheads. In this off-axis system, the cartridges may be replenished by ink conveyed through a series of flexible tubes from the main stationary reservoirs so only a small ink supply is propelled by carriage across the print zone, which is located “off-axis” from the path of printhead travel. Some or all of the main stationery reservoirs may be located in a region generally away from the interior of the printer.

These and other objects of the invention are addressed and solved by the inkjet printing apparatus and method set out below.

Examples of the invention will now be described by referring to the accompanying drawings:

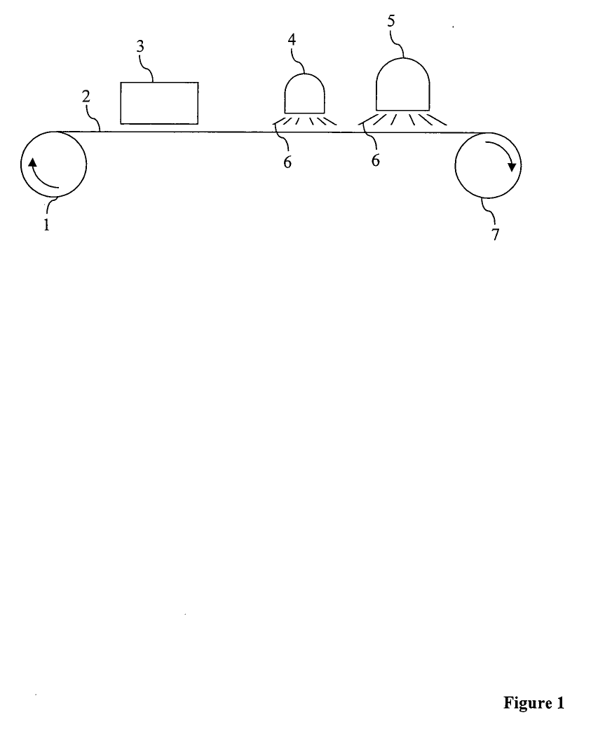

FIG. 1 illustrates an arrangement in which a radiation-curable ink is applied to a continuously-moving web by thermal inkjet printing and radiation cured; and

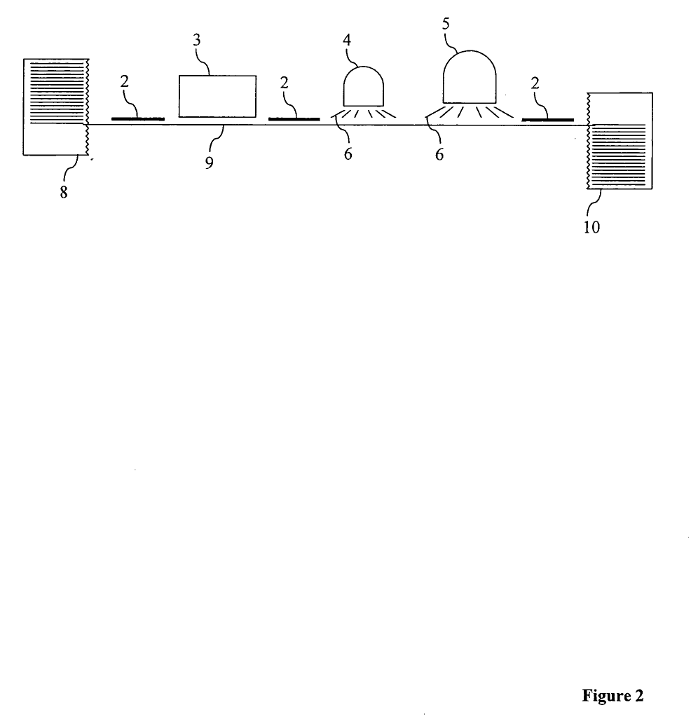

FIG. 2 illustrates an arrangement in which a radiation-curable ink is applied to a continuously-moving sheet feed system by thermal inkjet printing and radiation cured; and

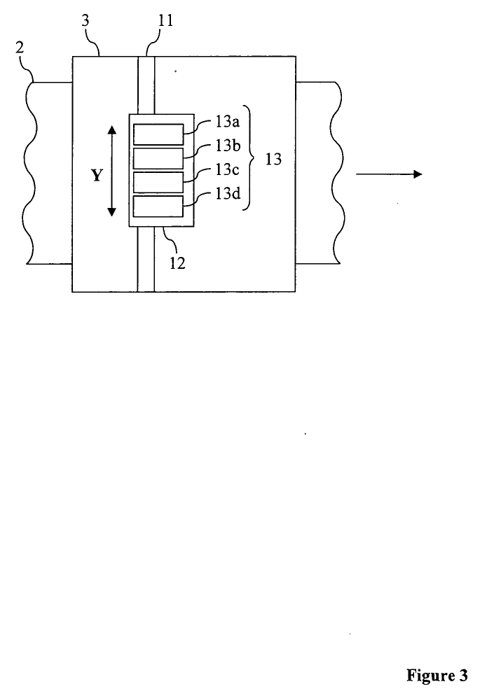

FIG. 3 illustrates an arrangement in which the thermal inkjet printing station of FIG. 1 comprises a bidirectionally-movable inkjet printer carriage in which is mounted a plurality of thermal inkjet printer cartridges with integral printheads; and

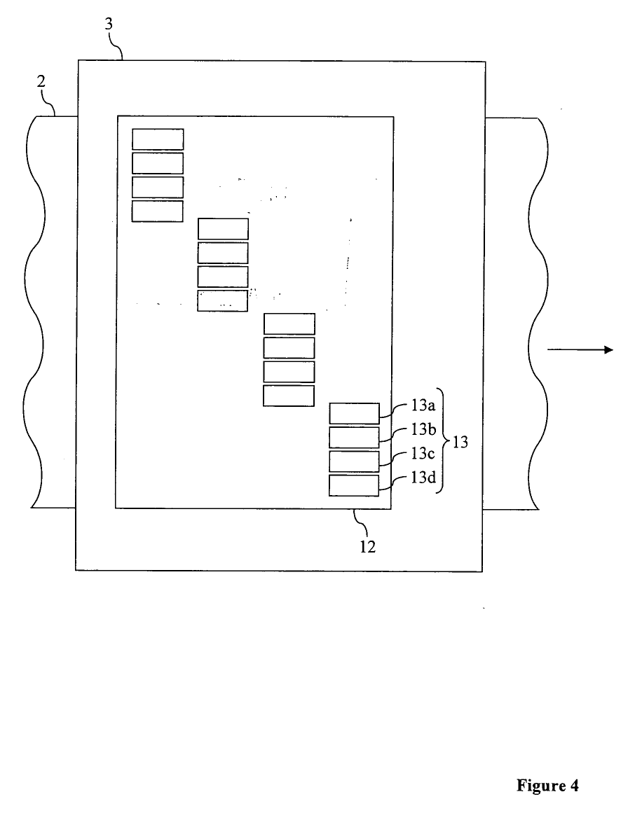

FIG. 4 illustrates an arrangement in which the thermal inkjet printing station of FIG. 1 comprises a carriage in which is mounted a plurality of thermal inkjet printer cartridges with integral printheads in fixed array.

### DETAILED DESCRIPTION OF THE INVENTION

The following description of the preferred embodiment(s) is merely exemplary and is in no way intended to limit the invention, its applications or uses.

The present invention provides a means of printing a radiation-curable ink with a desirable colour density onto semi-porous and non-porous industrial media.

To realise the full high resolution printing capability of thermal inkjet printing, it is essential that the transport mechanism for the continuously-moving industrial print media is able to move to and position the industrial print media with high precision and in synchronous action with the thermal inkjet printing mechanism.

Inkjet printing on various substrates other than paper is known. The term “industrial” print media herein means substrates other than regular printing paper and include plastics, foil packaging materials, and so forth, which may be supplied as webs, rolls or sheets. The preferred embodiments of the present invention relate to applications including, but not limited to corrugated containers, folding cartons, multiwall sacks, paper sacks, plastic bags, milk and beverage cartons, disposable cups and containers, labels, adhesive tapes, envelopes, newspapers, food wrappers, medical packaging etc.

The radiation-curable inkjet ink includes one or more radiation-curable compounds. Suitable examples of radiation-curable compounds include, without limitation, ethylenically unsaturated monomers and oligomers, which may be monofunctional or polyfunctional, and epoxy-functional monomers and oligomers, which may also be monofunctional or polyfunctional, such as alkyl acrylate, alkylene diacrylates, polyurethane acrylate oligomers, polyester acrylate oligomers, epoxy acrylates, bisphenol polyepoxide esters and ethers, and so on. The thermal inkjet ink compositions may further include a photoinitiator (photo-cationic or free-radical) or combination of photoinitiators for curing the radiation-curable compounds, one or more colorants (dyes and/or pigments), surfactants, and other desired components. In a preferred embodiment, thermal inkjet inks as described in GB 0519941.9 are employed.

By virtue of the printhead resistor configuration, the thermal inkjet printheads described here are typically characterized as being capable of printing at relatively high resolution, e.g. 600 dpi or greater. In addition, the thermal inkjet printheads are configured to print one of at least four colours, respectively. These colours are typically cyan (C), magenta (M), yellow (Y), and black (K). Moreover, the thermal inkjet printheads may also be configured to print other colours, such as light cyan (LC) and light magenta (LM). Since these colours are relatively standard for thermal inkjet printers, they are available in relatively large supply and thus easily obtained. In addition, fluids having these colours may be manufactured at higher and stricter standards. In use, when a printing operation requires colours other than those enumerated above, thermal inkjet printers typically combine at least two of these colours during the printing process to create “process colours”.

After inkjet printing, the printed ink is exposed to actinic radiation to cure the ink in the coating matrix by a free-radical or cationic-curing mechanism. Full-colour images may be printed using to a printing process with four or more colours of ink. When more than one colour is laid down in an area, the ink droplets of the colour first printed may be at least partially (tack) cured before the next colour is applied. Thus, a four-colour black area can be physically and visually very different from an area that receives only one layer and one inkjet ink colour (such as a yellow area).

By actuating nozzles that are aligned in the direction of web movement, but associated with different colours such as cyan and yellow, for example, the inkjet printer can combine the three colours magenta, cyan and yellow to print in a wider variety of colours.

In a preferred arrangement, the inkjet printheads are cartridge-based, thereby eliminating the need for an ink recirculation apparatus.

Although the descriptions hereinabove make specific reference to a minimum fixed array of commercial thermal inkjet print cartridges with integral printheads, it should be understood that the present invention may include any reasonably suitable number of thermal inkjet print cartridges with integral printheads in complete registration. It should also be understood that the abilities of the inkjet printing apparatus to print on various substrate types greatly increases with any increase in the number of printheads implemented.

Further, although inks (including free-radically curable inks, cationically-curable inks, and hybrid-type inks) used in the above embodiment are cured by irradiating with UV light, the inks are not limited to this, and inks cured by irradiating light other than UV light may be employed. Herein, the word “light” is used in a broad sense, including electromagnetic waves such as UV ray, electron-beam, X-ray, visible light and infra red.

Referring to FIG. 1, there is shown a thermal inkjet printing apparatus including a feed-out roller 1, a conveying mechanism (not shown) for conveying an industrial print medium 2 having a long length and a predetermined width along a conveying path, an inkjet printer station 3 for carrying the plurality of thermal inkjet print cartridges 13 with integral printheads (not shown), a preliminary curing device 4, and a main radiation curing device 5, both emitting radiation 6 for curing of the inkjet printed image, and a winding roller 7 to wind the industrial print medium 2 after thermal inkjet printing and radiation curing of the printed image on said industrial print medium 2.

In FIG. 2 there is shown a thermal inkjet printing apparatus similar to that of FIG. 1, but with the addition of a first sheet stack 8 to supply an industrial print medium 2 in single sheet form that is conveyed along a conveying path 9, driven by a conveying mechanism (not shown) and conveyed directly beneath an inkjet printer station 3 carrying a plurality of thermal inkjet print cartridges 13 with integral printheads (not shown), and conveyed directly beneath a preliminary curing device 4 and beneath a main radiation curing device 5, both emitting radiation 6 for curing of the inkjet printed image, the inkjet printed sheets to be received by a final sheet stack 10.

In FIG. 3, there is shown a planographic view of one embodiment of the inkjet printer station 3.

As shown in FIG. 3, the inkjet printer station 3 includes an inkjet printer carriage 12, bidirectionally-movable horizontally, and perpendicularly to, the direction of movement of the industrial print medium 2 conveyed directly beneath the inkjet printer station 3. The inkjet printer carriage 12 is bidirectionally-movable along a carriage rail 11 that extends along the scanning direction (printing direction) Y. A plurality of thermal inkjet print cartridges 13 with integral printheads for jetting inks having a characteristic of being radiation curable by actinic radiation are mounted and supported within the inkjet printer carriage 12.

In FIG. 4, there is shown a planographic view of a preferred embodiment of the inkjet printer station 3.

As shown in FIG. 4, the inkjet printer station 3 includes an inkjet printer carriage 12 in which is mounted and supported a plurality of thermal inkjet printer cartridges 13 with integral printheads positioned in fixed array at a set distance above a continuously-moving industrial print medium 2 conveyed directly beneath the inkjet printer station 3.

Many modifications and variations of the present invention are possible in light of the above teachings. Thus, it will be appreciated by persons skilled in the art that the present invention is not limited by what has been particularly shown and described herein above. Rather, the scope of the invention is defined by the claims which follow:

1. A method for printing and curing of a radiation-curable thermal inkjet ink comprising steps of:
applying a radiation-curable thermal inkjet ink to a print substrate; and
curing the radiation-curable thermal inkjet ink by exposure to a radiation energy.

2. The method according to claim 1, wherein the radiation-curable thermal inkjet ink is applied to a print substrate by use of a first inkjet printer station.

3. The method according to claim 2, wherein the print substrate is conveyed on a continuously moving web.

4. The method according to claim 2, wherein the first inkjet printer station is configured for bidirectional printing or fixed page-wide array printing.

5. The method according to claim 4, wherein the first inkjet printer station comprises a plurality of thermal inkjet printheads.

6. The method according to claim 5, wherein the plurality of thermal inkjet printheads are ink-containing print cartridges with integral printheads.

7. The method according to claim 1, wherein the radiation-curable thermal inkjet ink is cured by use of a first radiation-curing device configured to deliver radiation energy at the radiation-curable thermal inkjet ink applied to the print substrate.

8. The method according to claim 7, wherein the first radiation-curing device is disposed downstream of the first inkjet printer station.

9. The method according to claim 2, wherein the radiation energy is ultraviolet radiation energy or thermal radiation energy.

10. The method according to claim 2, wherein the inkjet printer station comprises a plurality of thermal inkjet printheads configured for receiving a plurality of radiation-curable inkjet inks from an ink supply apparatus.

11. The method according to claim 10, wherein the ink supply apparatus is disposed off-board.

12. The method according to claim 11, wherein a plurality of flexible tubes connectably join the plurality of radiation-curable inkjet inks from the ink supply apparatus to the plurality of thermal inkjet printheads.

13. The method according to claim 12, wherein the ink supply apparatus further comprises a pump to pump the plurality of radiation-curable inkjet inks through the plurality of flexible tubes to the plurality of thermal inkjet printheads.

14. The method according to claim 10, wherein the plurality of radiation-curable inkjet inks includes at least one of cyan, magenta, yellow and black.

15. The method according to claim 14, wherein the plurality of radiation-curable inkjet inks further includes at least one of light cyan and light magenta.

16. The method according to claim 2, wherein a second radiation-curing device is disposed downstream of the inkjet printer station, but upstream of the first radiation-curing device.

17. The method according to claim 16, wherein the radiation energy is ultraviolet radiation energy or thermal radiation energy.

18. The method according to claim 1, wherein the print substrate is semi-porous.

19. The method according to claim 1, wherein the print substrate is non-porous.

20. An apparatus for printing and curing a radiation-curable thermal inkjet ink, comprising:
an inkjet printer station, the inkjet printer station configured for applying the radiation-curable thermal inkjet ink to a print substrate;
a radiation-curing device; and
a means for transporting the print substrate from an initial position to a position adjacent the first inkjet printer station, and then to a position adjacent to the radiation-curing device, whereby the radiation-curable thermal inkjet is applied onto the print substrate by the inkjet printer station, and is subsequently cured by radiation energy emitted by the first radiation-curing device.

21. The apparatus according to claim 20, wherein the inkjet printer station is fixedly mounted at a preconfigured distance above the receiver surface of the print substrate.

22. The apparatus according to claim 20, wherein the inkjet printer station is configured for bidirectional printing at a preconfigured distance above the receiver surface of the print substrate.

23. The apparatus according to claim 20, wherein the first radiation-curing device is disposed downstream of the first inkjet printer station.

24. The apparatus according to claim 23, wherein the first radiation-curing device is configured to deliver radiation energy at the radiation-curable thermal inkjet ink applied to the print substrate.

25. The apparatus according to claim 24, wherein the radiation energy is ultraviolet radiation energy or thermal radiation energy.

26. The apparatus according to claim 20, wherein the inkjet printer station comprises a plurality of thermal inkjet ink-containing print cartridges with integral printheads.

27. The apparatus according to claim 20, wherein the thermal inkjet printer station comprises a plurality of thermal inkjet printheads configured for receiving a plurality of radiation-curable inkjet inks from an ink supply apparatus.

28. The apparatus according to claim 27, wherein the ink supply apparatus is off-board.

29. The apparatus according to claim 20, wherein repetitive print is applied at one or more additional inkjet printer stations.

30. The apparatus according to claim 29, wherein the one or more additional inkjet printer stations are disposed downstream of the first inkjet printer station and upstream of the first radiation-curing device.
